(19) United States
(12) Patent Application Publication
(10) Pub. No.: US 2017/0308095 A1
(43) Pub. Date: Oct. 26, 2017

(54) METHOD AND DEVICE FOR GUIDING A VEHICLE IN A PARKING LOT

(71) Applicant: Robert Bosch GmbH, Stuttgart (DE)

(72) Inventors: Albrecht Irion, Stuttgart (DE); Hans-Joerg Mathony, Tamm-Hohenstange (DE); Rolf Nicodemus, Bietigheim-Bissingen (DE); Stefan Hoffmann, Bietigheim (DE); Stefan Nordbruch, Kornwestheim (DE); Holger Mielenz, Ostfildern (DE)

(21) Appl. No.: 15/521,548

(22) PCT Filed: Sep. 29, 2015
(86) PCT No.: PCT/EP2015/072432

§ 371 Date: Apr. 24, 2017

(30) Foreign Application Priority Data
Oct. 27, 2014 (DE) 10 2014 221 751.2

(51) Int. Cl. G05D 1/02; B60W 30/06; G08G 1/14

(52) U.S. Cl. CPC G05D 1/0276; G08G 1/146; B60W 30/06; B60W 2550/10; B60W 2550/402

(57) ABSTRACT

A method is described for guiding a vehicle in a parking lot, in which a route in the parking lot from a starting position to a target position is ascertained off-board the vehicle, and at least a section of the route is transmitted to the vehicle via a communications network, and when traveling the section, the vehicle is monitored for a deviation during the autonomous driving of the section with the aid of an off-board monitoring system. In addition, a corresponding device and computer program directed to a parking system are described as well.

The invention relates to a method for guiding a vehicle in a parking lot, in which a route in the parking lot from a starting position to a target position is ascertained off-board the vehicle, and at least a section of the route is transmitted to the vehicle via a communications network, and when traveling the section, the vehicle is monitored for a deviation during the autonomous driving of the section with the aid of an off-board monitoring system. In addition, the invention relates to a corresponding device, to a parking system as well as to a computer program.

### FIELD OF THE INVENTION

The present invention relates to a method and a device for guiding a vehicle in a parking lot. Furthermore, the present invention relates to a parking system for vehicles and to a computer program.

### BACKGROUND INFORMATION

In what is generally referred to as fully automated (autonomous) valet parking, a driver parks his vehicle at a drop-off point, such as in front of a parking garage, and from there the vehicle then drives on its own to a parking position/parking bay and back again to the drop-off point.

However, such valet parking can usually not be undertaken by current vehicles or vehicles soon to arrive on the market or if at all, it can be carried out only in a technically very complex manner since the vehicle requires numerous supplementary systems (control units, sensors) as well as data for this purpose, which are generally not available in these vehicles.

### SUMMARY

An object of the present invention is to provide a method for guiding a vehicle within a parking lot, the method allowing even vehicles without such supplementary systems to nevertheless drive autonomously in the parking lot.

The objective on which the present invention is based may also be described as providing a corresponding device for guiding a vehicle in a parking lot.

Furthermore, the objective on which the present invention is based may also be described as providing a corresponding parking system for vehicles.

In addition, the objective on which the present invention is based may be described as providing a corresponding computer program.

According to one aspect, a method for guiding a vehicle in a parking lot is provided, in which
a route in the parking lot from a starting position to a target position is ascertained off-board the vehicle, and
at least a section of the route is transmitted to the vehicle via a communications network, and
while the section is being traveled, the vehicle is monitored for a deviation in the autonomous travel of the section with the aid of an off-board monitoring system.

According to a further aspect, a device for guiding a vehicle in a parking lot is provided, which includes
a processor, which is designed to ascertain a route in the parking lot from a starting position to a target position,
a communications interface, which is designed to transmit at least a section of the route to the vehicle via a communications network, and
a monitoring system, which is designed to monitor the vehicle during the autonomous travel of the section for a deviation while the section is being traveled.

According to a further aspect, a parking system for vehicles is provided; the parking system includes a parking lot that has one or more parking position(s), and the parking system includes the device for guiding a vehicle in a parking lot according to the present invention.

According to another aspect, a computer program is provided, which includes program code for carrying out the method for guiding a vehicle in a parking lot according to the present invention when the computer program is executed on a computer.

Thus, the present invention encompasses the specific idea of making only at least a section of the route available to the vehicle so that the vehicle is initially able to autonomously travel only said section of the route in the parking lot. The reason for this is that current vehicles are usually quite capable of traveling a section of the route autonomously, utilizing the driver-assistance systems that are at their disposal, but they lack the ability to travel the entire route all at once. In an advantageous manner, such vehicles are thereby able to drive in a parking lot autonomously without the vehicles having to have any kind of knowledge of the parking lot in this case. For example, information about a parking lot includes a topography of the parking lot, which is normally representable by a digital map. In other words, the vehicle need not know where an entrance is located, for example. In particular, the vehicle need not know the location of possible obstacles in the parking lot. In addition, the vehicle advantageously does not have to localize itself in the parking lot. Put another way, it does not need to know anything. The information is available off-board the vehicle or is ascertained outside the vehicle and made available to the vehicle in the form of a section.

A parking lot within the meaning of the present invention may also be referred to as a parking area and is used as a parking space for vehicles. The parking lot thus forms a continuous area which includes a plurality of parking positions (in case of a parking lot on private property) or a plurality of parking slots (in case of a parking lot on public property). According to a specific embodiment, the parking lot may be part of an enclosed parking structure. In particular, the parking lot is part of a garage.

Autonomous within the sense of the present invention particularly means that the vehicle navigates or drives on its own, i.e. without an intervention by a driver. Thus, the vehicle drives by itself in the parking lot without a driver having to control the vehicle or having to be in the vehicle in order to do so. Such an autonomously driving vehicle that is able to park and unpark automatically is also referred to as an AVP vehicle, for example. AVP is the abbreviation of “automatic parking valet” and may be translated as “automatic parking operation”. Vehicles without this AVP functionality, for example, are referred to as normal vehicles.

According to a specific embodiment, the communications network includes a WLAN and/or a mobile telephony network.

A drop-off position within the meaning of the present invention is a position at which a driver of the vehicle is able to leave his car for an autonomous parking operation and from where the driver can pick up the vehicle again at a later point in time.

A parking position within the meaning of the present invention describes a position at which the vehicle is meant to park autonomously.

In a specific embodiment, it is provided that the vehicle navigate or drive autonomously from the drop-off position to the parking position.

In a further specific embodiment, the vehicle parks in the parking position in an autonomous manner.

In another specific embodiment, the vehicle unparks from the parking position autonomously.

According to a further specific embodiment, the vehicle navigates or drives autonomously from the parking position to the drop-off position.

In another specific embodiment, in the event of a deviation, a compensation route for compensating for the deviation will be ascertained; the compensation route is transmitted to the vehicle via the communications network so that the vehicle is able to compensate for the deviation by driving the compensation route. This results in the specific technical advantage that a deviation is able to be compensated for because the driven section usually includes deviations as a result of inaccuracies of the environmental sensors of the vehicle, the algorithms and/or the actuators. In other words, the vehicle has not exactly followed the section predefined for the vehicle. A deviation therefore exists between the actual route and the setpoint route, i.e. between the actual section and the setpoint section. However, with the aid of the compensation route, this deviation is able to be compensated for or is able to be corrected. Put another way, the monitoring system notices when the vehicle has not traveled the predefined section and thereby detects the deviation.

In a further specific embodiment, a stop signal will be transmitted to the vehicle via the communications network in the event of a deviation, so that the vehicle is able to stop in response to the received stop signal. This provides the specific technical advantage that a collision risk is reduced inasmuch as a stopped vehicle is no longer able to drive against other objects or obstacles in the environment of the vehicle on its own.

According to another specific embodiment, sections of the route are transmitted to the vehicle via the communications network in succession so that the vehicle is able to drive the route section by section. In other words, the vehicle can drive the route one section at a time, in particular. Here, in succession may mean especially that the vehicle first has to travel the section before a further section immediately adjoining the section just passed through will be made available to the vehicle. Through the successive driving of the individual sections, the vehicle then advantageously travels from the starting position to the target position. As a whole, all sections that make up the complete route are provided to the vehicle one after the other, i.e. successively. In other words, the route is subdivided into sections that are made available to the vehicle successively, i.e. one after the other. In this instance, made available specifically means that the sections are transmitted to the vehicle via the communications network.

According to a specific embodiment, the sections all have the same length.

According to another specific embodiment, the respective length of the sections is a function of a degree of difficulty with regard to the travel along the section. For example, a straight section is longer than a winding section. The length thus depends on the current driving route section or on the complexity of the driving route.

According to another specific embodiment, the particular length of the sections is a function of the capability measure of the vehicle with regard to the autonomous driving task. In particular, the capability measure is based on capabilities or functionalities of the controller, the sensors, and the actuators. In other words, the particular length is selected as a function of the capabilities of the vehicle in terms of the extent to which it is able to drive autonomously or how well it is able to drive in an autonomous manner.

According to another specific embodiment, the particular length of the sections is a function of a traffic density or an object density. In other words, when many vehicles are located in the vicinity of the vehicle, then the sections are shorter than when comparatively fewer vehicles are located in the area of the vehicle. In other words, the length is selected as a function of the environment.

According to another specific embodiment, a parking route for parking in the parking position and/or an unparking route for unparking from the parking position is/are ascertained off-board the vehicle and transmitted to the vehicle via the communications network, thereby enabling the vehicle to park in the parking position or to unpark from the parking position in an autonomous manner. This offers the specific technical advantage that the vehicle is not required to be equipped with a parking assistant of its own. In other words, the vehicle itself does not have to have an autonomous parking functionality because the route required to allow the vehicle to park or unpark by traveling said route is determined off-board the vehicle. Thus, the vehicle itself does not need to know the precise dimensions of the parking position. In particular, the vehicle need not have knowledge of possible obstacles in the environment of the parking position. Put another way, the information is available off-board the vehicle and is made available to the vehicle via the communications network in the form of the parking or unparking route.

According to another specific embodiment, the vehicle parks or unparks on its own, i.e. autonomously or in a fully automated manner. In this specific embodiment, it is therefore not the case that a parking or unparking route is made available to the vehicle. Instead, the vehicle is merely guided to the parking position or guided to the drop-off position. The vehicle carries out the parking or unparking operation on its own and, in particular, ascertains the required route for parking or unparking by itself.

According to another specific embodiment, a return route back from the target position to the starting position is ascertained off-board in addition. At least a section of the return route is transmitted to the vehicle via the communications network, and during the autonomous travel of the section of the return route, the off-board monitoring system monitors the vehicle for a deviation while the section is being traveled. This offers the specific technical advantage that the vehicle is also able to be guided back to the starting position. The comments made in connection with the route from the starting position to the target position analogously also apply to the return route. In other words, a compensating route can be ascertained for the return route as well in case of a deviation, especially ascertained in a corresponding manner. In particular, it is also possible to send a stop signal to the vehicle if a deviation occurs during the return route travel. According to a specific embodiment, the successive transmission of the sections of the return route is analogously provided as well.

According to another specific embodiment, the starting position is a drop-off position at which the driver is able to leave his vehicle for an automatic parking operation, and that the target position is a parking position at which the vehicle may park autonomously, or vice versa. This offers the specific technical advantage of allowing the vehicle to perform an automated parking operation in the parking lot. That is to say, what is referred to as valet parking may automatically be carried out here, in particular.

Functionalities of the device result from functionalities of the method in a similar manner, and vice versa. Put another way, the device features result directly from the method features and vice versa.

According to a specific embodiment, the device is designed to execute or carry out the method of the present invention.

### BRIEF DESCRIPTION OF THE DRAWINGS

FIG. 1 shows a flow diagram of a method for guiding a vehicle in a parking lot.

FIG. 2 shows a device for guiding a vehicle in a parking lot.

FIG. 3 shows a parking system for vehicles.

FIGS. 4-10 show a respective instant at which an automatic parking operation is carried out.

### DETAILED DESCRIPTION

FIG. 1 shows a flow diagram of a method for guiding a vehicle in a parking lot.

According to a step 101, a route in the parking lot from a starting position to a target position is ascertained off-board the vehicle. In a step 103, at least a section of the route is transmitted to the vehicle via a communications network. According to a step 105, while the vehicle is traveling the section, an off-board monitoring system monitors the vehicle for a deviation in the autonomous travel of the section. Thus, the vehicle is guided from outside the vehicle, i.e. in a remote-controlled manner.

The step of monitoring according to the present invention provides the specific technical advantage that the occurrence of problems or of dangerous situations is able to be detected. For example, it can be detected if the vehicle fails to autonomously travel the predefined section.

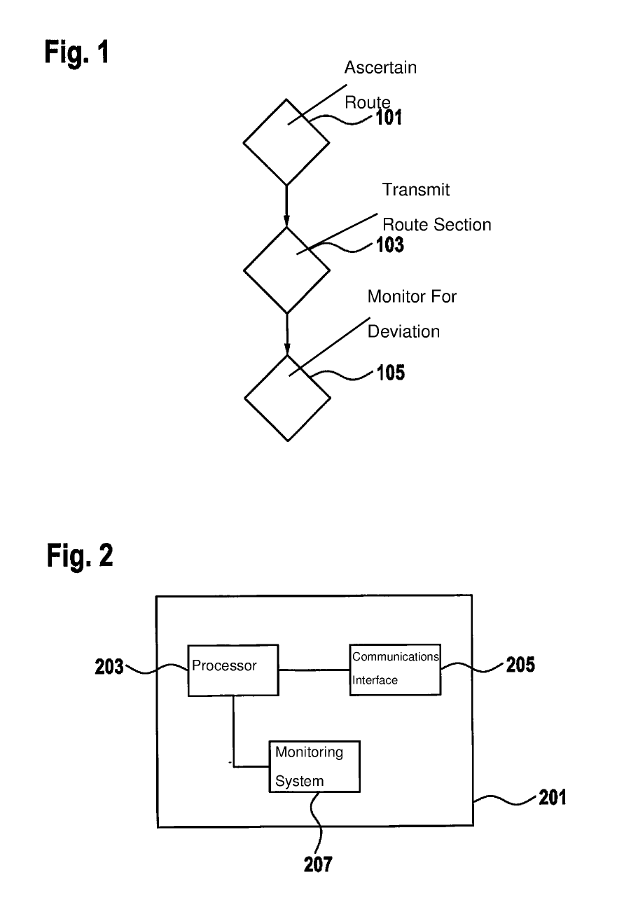

FIG. 2 shows a device 201 for guiding a vehicle within a parking lot.

Device 201 includes a processor 203, which is set up to ascertain a route in the parking lot from a starting position to a target position. In addition, device 201 includes a communications interface 205, which is set up to transmit at least a section of the route to the vehicle via a communications network. In addition, device 201 includes a monitoring system 207, which is set up to monitor the vehicle during its autonomous travel of the section for a deviation while traveling said section.

According to a specific embodiment, device 201 is designed to execute or carry out the method according to the present invention, in particular the method according to FIG. 1.

The device is an off-board device, i.e. it does not itself exist in the vehicle or is not located there. Thus, an off-board remote control of the vehicle is possible. In the process, the vehicle is informed how to drive in the parking lot. In order to be able to drive within the parking lot in an autonomous manner, the vehicle must thus simply drive along the predefined section. It requires no information about the parking lot for its autonomous travel. In particular, the vehicle does not have to localize itself in the parking lot for the autonomous travel in the parking lot. This is normally very difficult to do since a localization generally requires a line of sight to satellites, e.g., GPS satellites. In parking lots, in particular in enclosed parking structures or parking garages, this is normally not the case.

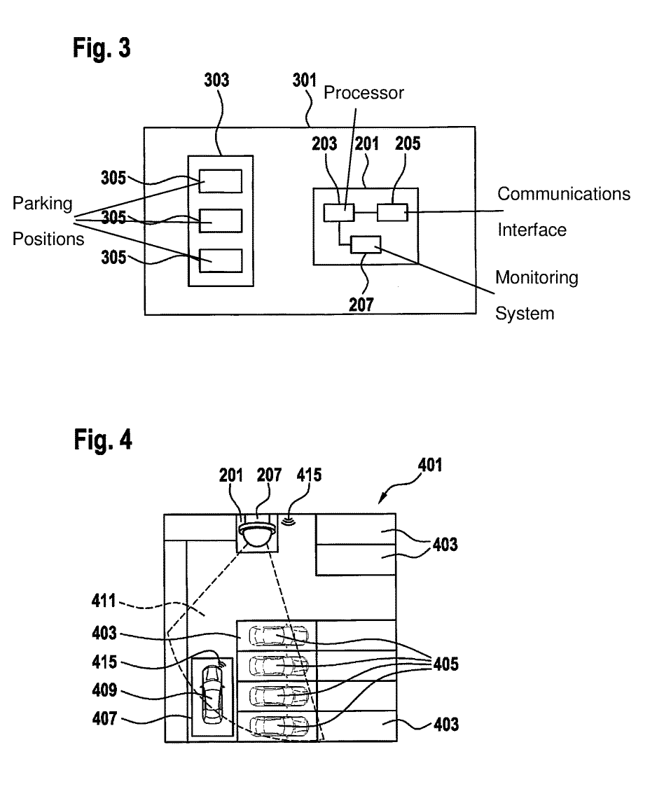

FIG. 3 shows a parking system 301 for vehicles.

Parking system 301 includes a parking lot 303. The parking lot has one or more parking position(s) 305. In addition, parking system 301 includes device 201 from FIG. 2.

FIGS. 4 through 10 respectively show an instant during an execution of an automated parking operation, i.e. what is termed automatic valet parking.

Shown in the figures is a parking lot 401 which includes a plurality of parking positions 403, which correspond to parking slots or parking areas. In other words, vehicles are able to park at these parking positions 403. Parked vehicles 405 are AVP vehicles, for example.

An AVP vehicle 409 has been parked at a drop-off position 407. It is now supposed to drive to its allocated parking position.

FIG. 4 shows vehicle 409, which is parked at drop-off position 407. Device 201 according to the present invention is provided; however, only monitoring system 207 is shown here for reasons of clarity. Further elements of device 201 are not depicted in order not to confuse.

According to a specific embodiment, monitoring system 207 includes one or more camera(s), especially video cameras. In a further specific embodiment, monitoring system 207 includes one or more radar sensor(s).

Device 201 thus detects the presence of AVP vehicle 409 at drop-off position 407 with the aid of monitoring system 207.

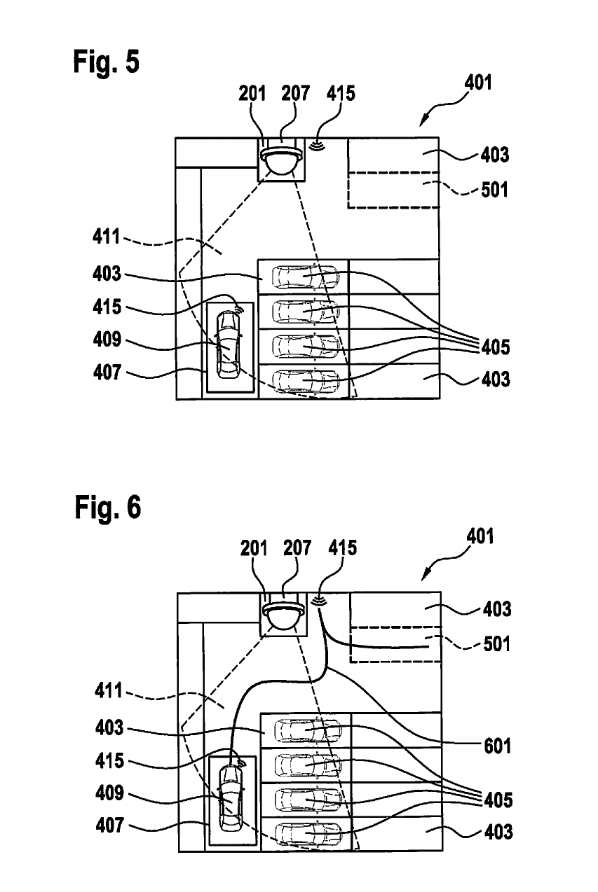

As a result, device 201 subsequently ascertains a parking position for vehicle 409, which is indicated by dashed lines in FIG. 5 and has been provided with reference numeral 501.

A cone bearing reference numeral 411 symbolically represents an exemplary detection angle of monitoring system 207. In particular, the communication between device 201 and vehicle 409 is carried out via a wireless communications network, especially a WLAN. This is symbolically represented by a corresponding pictogram to which reference numeral 415 is pointing.

In addition, device 201 ascertains a way or a path or a route from drop-off position 407 to parking position 501. The route is denoted by reference numeral 601 according to FIG. 6.

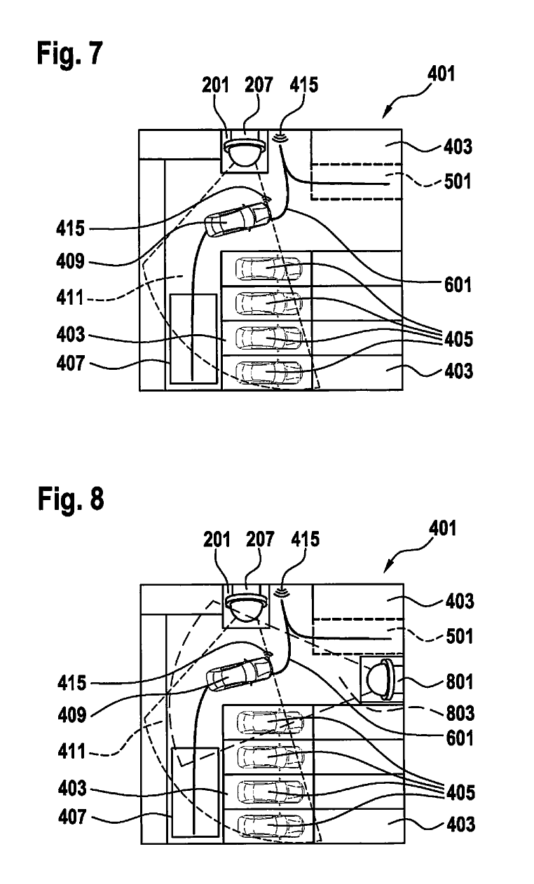

It is provided that ascertained route 601 be subdivided into sections which are transmitted to the vehicle, in particular transmitted to the vehicle in successive fashion. FIG. 7 shows how vehicle 409 now drives along ascertained route 601 section by section. While the vehicle is driving, it is monitored with the aid of monitoring system 207. FIG. 8 shows an exemplary monitoring camera 801 in parking lot 401; the camera has a corresponding detection angle 803 within which vehicle 409 is able to be detected by monitoring camera 801. A monitoring camera in the sense of the present invention is a video camera, in particular.

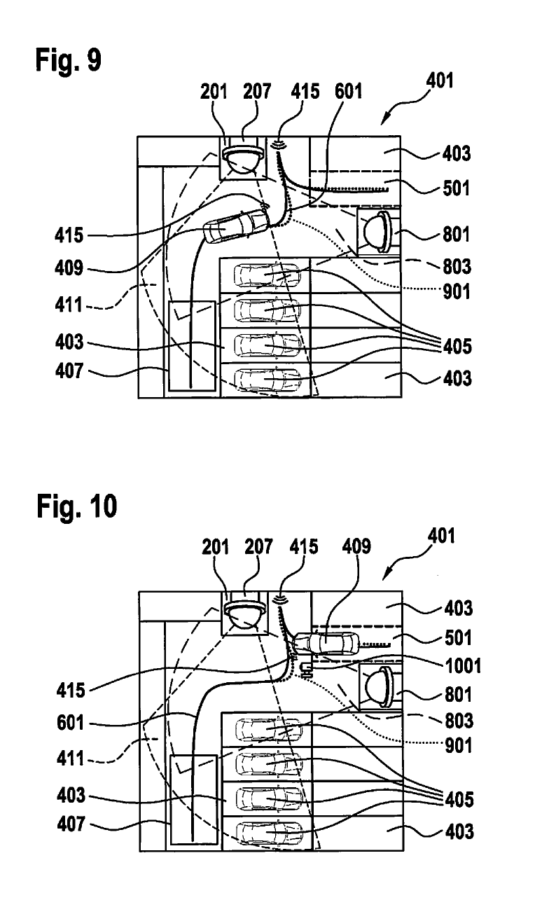

If monitoring system 207 has detected a deviation during the traveling of route 601, device 201 calculates or determines a compensation path or a compensation route. This is illustrated in FIG. 9, where the compensation route has been provided with reference numeral 901.

A parking operation as shown in FIG. 10 is able to be carried out with the aid of a parking-assistance system, i.e. by the vehicle itself, according to a specific embodiment. To do so, the vehicle is equipped with a symbolically depicted environmental sensor system 1001, which includes one or more radar sensor(s) and/or one or more ultrasonic sensor(s), for example. In another specific embodiment, device 201 may alternatively be responsible for the calculation or ascertainment of the corresponding parking route. The same applies to the unparking operation.

The way back from parking position 501 to drop-off position 407 takes place in a similar manner. Here, too, a corresponding return route will then be ascertained and the vehicle be monitored during the stepwise driving of the return route; if required, corresponding compensation paths or compensation routes are calculated and transmitted to the vehicle.

Thus, the present invention encompasses the specific idea of providing a technical concept that allows for fully automatic (autonomous) valet parking by vehicles that are equipped only with currently already known vehicle-assistance systems. Here, the inventive thought in particular includes the idea of a remote control of the vehicle, especially with the aid of device 201, which may be part of a parking-lot management system or a parking-lot administration system, for example. A parking-lot administration system coordinates an allocation of parking positions, among other things.

In other words, this specifically means that only the device must have information about the target position (parking bay/parking position), about a route to be traveled to the target position or also back to the drop-off position, about a position of the vehicle within the parking lot, e.g., within the parking garage, and about an interpretation and a reaction selection/generation in special situations. The vehicle itself simply drives the respective predefined way (path) or route without knowing, or having to know, its precise position itself. According to the present invention, the path to be driven or the route to be driven is represented by a multitude of sections (individual sections) of the route or the path. In other words, the device, in particular the parking-lot management or the parking-lot administration, transmits to the vehicle sections (partial pieces) of the entire route from the drop-off position (also referred to as drop-off point) to the parking position (e.g., to the parking bay) or from the parking position (parking bay) to the drop-off point, the transmission preferably taking place repeatedly.

This is technically meaningful since currently known vehicle systems are usually able to drive only short distances, and driven distances usually include deviations on account of inaccuracies of the sensors, the algorithms, and actuators.

According to a specific embodiment, it is provided that the autonomous travel of the vehicle be monitored the entire time. In particular a position of the vehicle during its autonomous driving is determined. In other words, the vehicle is located, especially with the aid of the monitoring system, which may include a video camera, for instance. The monitoring system may be referred to as a parking space monitoring system, in particular.

If it is determined in the process that the vehicle is not precisely following the route (difference between setpoint and actual), then a correction or compensation path/route is calculated for the vehicle according to a specific embodiment and made available to the vehicle via the communications network.

According to a specific embodiment, in the event that a path is blocked (e.g., by objects in the path), a way around the corresponding obstacle may be calculated or determined, preferably by the parking lot management system, and the vehicle be guided around the obstacle in this manner. In other words, if an obstacle is encountered along the route, a bypass route for circumventing the obstacle is ascertained off-board the vehicle according to a specific embodiment, and the vehicle is guided around the obstacle based on the bypass route.

Furthermore, according to a specific embodiment, in special situations the device possibly interrupts the travel by a stop signal.

Traveling a section of the way or a segment is usually possible by utilizing assistance systems that are currently available on the market (including route planning systems) or those of the next generation.

According to a specific embodiment, a parking operation into the parking bay/parking position with the aid of a parking assistant/parking system is provided. This especially means that the parking management system guides the vehicle only along the path to the parking position; there, the parking management system provides the position of the parking spot to the vehicle, or more precisely, to the parking assistance system in the vehicle, which will then take over the parking operation. In a corresponding manner, it is particularly provided that the vehicle autonomously unpark from the parking position with the aid of the parking assistance system.

In another specific embodiment, this, i.e. the calculation of the parking operation, is accomplished with the aid of the device, in particular with the aid of the parking management system. Of course, the same also applies to the unparking operation.

According to a specific embodiment, the communication via the communications network takes place in encrypted form, the communication being carried out via C2X systems, in particular. Here, “C2X” stands for car-to-car infrastructure, i.e. a communication between a vehicle and a stationary infrastructure.

The advantage according to the present invention thus is especially to be seen in the ability to carry out autonomous valet parking with currently known vehicles.

In another specific embodiment, the parking garage/the parking lot has a separate region reserved for the fully automated or autonomous valet parking. This advantageously makes it possible to prevent potential problems resulting from mixed traffic (AVP vehicles and normal vehicles) and/or from pedestrians. In other words, the parking lot has a reserved area for autonomously driving vehicles according to a specific embodiment.

1.-14. (canceled)

15. A method for guiding a vehicle in a parking lot, comprising:
ascertaining, off-board the vehicle, a route in the parking lot from a starting position to a target position;
transmitting at least a section of the route to the vehicle via a communications network; and
while the vehicle is driving on the section, monitoring the vehicle for a deviation in an autonomous travel of the section, with the aid of an off-board monitoring system.

16. The method as recited in claim 15, further comprising:
if the monitoring determines that the deviation is present, ascertaining a compensation route for compensating for the deviation; and
transmitting the compensation route to the vehicle via the communications network so that the vehicle is able to compensate for the deviation by driving the compensation route.

17. The method as recited in claim 15, further comprising:
if the monitoring determines that the deviation is present, transmitting a stop signal to the vehicle via the communications network; and
receiving the stop signal by the vehicle so that the vehicle is able to stop in response to the received stop signal.

18. The method as recited in claim 15, wherein the transmitting includes successively transmitting sections of the route to the vehicle via the communications network so that the vehicle is able to travel the route section by section.

19. The method as recited in claim 15, wherein:
the route is at least one of a parking route for parking in and an unparking route for unparking from a parking position, and
the parking route and the unparking route are ascertained off-board the vehicle and transmitted to the vehicle via the communications network so that the vehicle is able to one of park autonomously in and unpark autonomously from the parking position.

20. The method as recited in claim 15, further comprising:
ascertaining a return route back from the target position to the starting position off-board the vehicle; and
transmitting at least a section of the return route to the vehicle via the communications network, the off-board monitoring system monitoring the vehicle during an autonomous travel of the section of the return route for a deviation in traveling the section.

21. The method as recited in claim 15, wherein:
the starting position is a drop-off position at which a driver is able to leave the vehicle for an automatic parking operation, and
the target position is a parking position one of at which the vehicle is able to park automatically and from which the vehicle is able to unpark automatically.

22. The method as recited in claim 21, wherein the vehicle is guided by remote control at least one of from the drop-off position to the parking position, and to the drop-off position from the parking position.

23. The method as recited in claim 15, wherein:
the target position is a parking position, and
the vehicle at least one of parks autonomously in the parking position and unparks autonomously from the parking position.

24. The method as recited in claim 15, further comprising:
in case of an obstacle along the route, ascertaining, off-board the vehicle, a bypass route for circumventing the obstacle; and
guiding the vehicle around the obstacle based on the bypass route.

25. A device for guiding a vehicle in a parking lot, comprising:
a processor for ascertaining a route in the parking lot from a starting position to a target position;
a communications interface for transmitting at least a section of the route to the vehicle via a communications network; and
a monitoring system for monitoring the vehicle for a deviation in an autonomous travel of the section while the section is traveled.

26. A parking system for a vehicle, comprising:
a parking lot that has at least one parking position; and
a device for guiding a vehicle in a parking lot, the device including:
a processor for ascertaining a route in the parking lot from a starting position to a target position,
a communications interface for transmitting at least a section of the route to the vehicle via a communications network, and
a monitoring system for monitoring the vehicle for a deviation in an autonomous travel of the section while the section is traveled.

27. The parking system as recited in claim 26, wherein the parking lot has a reserved area for autonomously driving vehicles.

28. A computer program including program code for executing on a computer a method for guiding a vehicle in a parking lot, the method comprising:
ascertaining, off-board the vehicle, a route in the parking lot from a starting position to a target position;
transmitting at least a section of the route to the vehicle via a communications network; and
while the vehicle is driving on the section, monitoring the vehicle for a deviation in an autonomous travel of the section, with the aid of an off-board monitoring system.
